(19) United States
(12) Patent Application Publication
(10) Pub. No.: US 2021/0278509 A1
(43) Pub. Date: Sep. 9, 2021

(54) AUTOMATED SCANNER SYSTEM

(71) Applicant: MANUFACTURING AUTOMATION SYSTEMS, LLC, PAINTED POST, NY (US)

(72) Inventors: Matta Rizkallah, PAINTED POST, NY (US); Jacob Cipriano, PAINTED POST, NY (US)

(73) Assignee: MANUFACTURING AUTOMATION SYSTEMS, LLC, PAINTED POST, NY (US)

(21) Appl. No.: 17/191,504

(22) Filed: Mar. 3, 2021

Related U.S. Application Data
(60) Provisional application No. 62/984,510, filed on Mar. 3, 2020.

(51) Int. Cl. G01S 7/481; G01S 17/89

(52) U.S. Cl. CPC G01S 7/4817; G01S 7/4813; G01S 17/89

(57) ABSTRACT

An automated scanner system for scanning an object at multiple angles. The system includes a housing having a plurality of motion assemblies connected thereto. Each motion assembly is movable along a separate axis of motion within the housing. The system also includes a scanner attached to at least one of the plurality of motion assemblies and each scanner is adapted to take one or more measurements. The system has a measurement target zone within the housing. Each scanner and motion assembly moves relative to the measurement target zone and the scanner is directed toward the measurement target zone. The plurality of motion assemblies includes at least a first motion assembly and a second motion assembly. The first motion assembly moves along a first axis and the second motion assembly moves along a different, second axis.

### CROSS-REFERENCE TO RELATED APPLICATION

The present application claims priority to and the benefit of U.S. Provisional Patent Application Number 62/984,510, filed on Mar. 3, 2020 and entitled “Automated Scanner System,” the entirety of which is incorporated herein by reference.

### BACKGROUND OF THE INVENTION

### 1. Field of the Invention

The present invention relates to a turnkey measurement system and, more particularly, to an automated scanner system for taking one or more measurements of a device under test (DUT).

### 2. Description of Related Art

Generally, turnkey systems are computer systems customized for a particular application. Specifically, turnkey systems include all the hardware and software necessary to execute every task of the application. In other words, the user only needs to initiate the process in order for the turnkey system to begin performing all tasks.

Scanning systems are used to take measurements and determine the structure of the object within the scanning system. Current scanning systems often use photogrammetry to create a 3D model based on a series of photographs. For example, the scanning systems uses a CMOS sensor to take numerous, rapid digital images. The problem with current scanning systems is that imager (e.g., CMOS sensor) is in one fixed location. Thus, the imager is limited in the data that it can retrieve and process regarding the object in the scanner.

Further, any 3D scanning system has a limited field-of-view. To scan larger parts, the system takes multiple scans and aligns them in post-process using fiducial features. Using 3D fiducials presents the following problem: optical 3D measurements tend to result in artifacts from reflection and refraction of light, typically near sharp edges, which can distort 3D features and limit the accuracy of 3D fiducial features.

Therefore, there is a need for an easy-to-use, automated scanner system with a movable imager for scanning the object at multiple angles.

### BRIEF SUMMARY OF THE INVENTION

The present disclosure is directed to an automated scanner system for scanning an object at multiple angles. According to an aspect, the present invention is an automated scanner system. The system includes a housing having a motion assembly connected thereto. The motion assembly is movable along a first axis of motion within the housing. A scanner is attached to the motion assembly and is adapted to take one or more measurements. The system also has a measurement target zone within the housing. The scanner and motion assembly move relative to the measurement target zone and the scanner is directed toward the measurement target zone.

According to another aspect, the present invention is an automated scanner system. The system includes a housing having a plurality of motion assemblies connected thereto. Each motion assembly is movable along a separate axis of motion within the housing. The system also includes a scanner attached to at least one of the plurality of motion assemblies and each scanner is adapted to take one or more measurements. The system has a measurement target zone within the housing. Each scanner and motion assembly moves relative to the measurement target zone and the scanner is directed toward the measurement target zone. The plurality of motion assemblies includes at least a first motion assembly and a second motion assembly. The first motion assembly moves along a first axis and the second motion assembly moves along a different, second axis.

This and other aspects of the invention will be apparent from the embodiments described below.

### BRIEF DESCRIPTION OF THE SEVERAL VIEWS OF THE DRAWING(S)

The present invention will be more fully understood and appreciated by reading the following Detailed Description in conjunction with the accompanying drawings. The accompanying drawings illustrate only typical embodiments of the disclosed subject matter and are therefore not to be considered limiting of its scope, for the disclosed subject matter may admit to other equally effective embodiments. Reference is now made briefly to the accompanying drawings, in which:

FIG. 1A is a perspective view of the automated scanner system, according to a single-axis embodiment;

FIG. 1B is a perspective view of a stand-alone automated scanner, according to an embodiment;

FIG. 1C is a perspective view of a stand-alone scanner mounted within a larger automated system, such as a robotic work cell, according to an embodiment;

FIG. 2 is a perspective view of the automated scanner system, according to a two-axis parallel scanning motion embodiment;

FIG. 3 is a perspective view of the automated scanner system, according to a three-axis embodiment;

FIG. 4 is a perspective view of the automated scanner system, according to a two-axis perpendicular scanning motion embodiment;

FIG. 5 is a perspective view of the automated scanner system, according to a three-axis perpendicular and rotary axis scanning motion embodiment;

FIG. 6 is a perspective of a multi axes automated scanner system with a rotational C axis and dual opposing scanners, according to an embodiment;

FIG. 7 is a perspective view of a motion assembly (or components thereof) with the scanning X-axis motion and the repositioning C-axis motion of the DUT, according to an embodiment;

FIG. 8 is a partial, sectional, front view of the automated scanner system with opposing scanners, according to an embodiment;

FIG. 9 is a perspective view of a larger automated system, such as a robotic work cell, according to an alternative embodiment;

FIG. 10 is a compiled three-dimensional shape compared in the S-Series Analyzer software application against the uploaded three-dimensional model generated from a CAD system;

FIG. 11 is a perspective view of a Computer Numerical Control (CNC) holding a scanner tool, according to an embodiment;

FIG. 12 is a perspective view of a Computer Numerical Control (CNC) holding a scanner tool, according to an alternative embodiment; and

FIG. 13 is a perspective view of a Computer Numerical Control (CNC) holding a scanner tool, according to another alternative embodiment.

### DETAILED DESCRIPTION OF THE INVENTION

Aspects of the present invention and certain features, advantages, and details thereof, are explained more fully below with reference to the non-limiting examples illustrated in the accompanying drawings. Descriptions of well-known structures are omitted so as not to unnecessarily obscure the invention in detail. It should be understood, however, that the detailed description and the specific non-limiting examples, while indicating aspects of the invention, are given by way of illustration only, and are not by way of limitation. Various substitutions, modifications, additions, and/or arrangements, within the spirit and/or scope of the underlying inventive concepts will be apparent to those skilled in the art from this disclosure.

The present invention is an automated scanner system. The purpose of the system is to take one or more measurements of a device under test (DUT) with lasers or light to determine if the DUT has the correct physical attributes. Generally, the automated scanner system includes one or more motion assemblies with one or more scanners attached thereto. The scanners can include, but are not limited to: a three-dimensional (3D) profile scanner, area scan camera, line scan camera, pattern projection camera, multiple cameras imaging around DUT, telecentric lensing, displacement laser scanner, laser micrometer, other laser-based devices, and other tactile-based devices (e.g., touch probe or linear variable differential transducer (LVDTs)). Scanners can be configured in various configurations such as a single scanner, an opposing dual scanner, or an array of scanners for each motion system. The motion assembly can include but is not limited to: linear servo and/or rotary servo motors, stepper motors, manual hand rank driving ballscrews, leadscrews, rack and pinion, linear ball or roller bearing rail, air bearing stages, belt-driven mechanism, crank, conveyors, and robots. The motion assembly moves scanner(s) around DUT while capturing area images (with or without telecentric lensing) and/or line scan images and/or two-dimensional cross-sectional scans and/or single-dimensional point scans which is then compiled in post processor for the purpose of conducting measurements and defect inspection. Some scanners collect three-dimensional point cloud data that is compiled and/or stitched in a manner to form three-dimensional shapes while other scanners collect four-dimension data, as described in detail below.

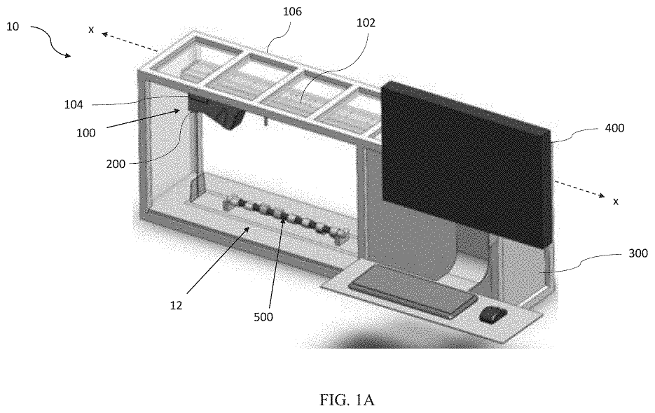

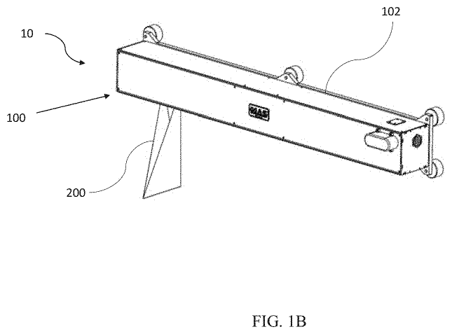

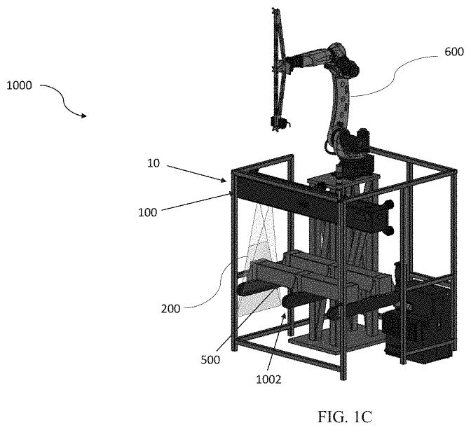

Referring first to FIG. 1A, there is shown a perspective view of the automated scanner system 10, according to a single-axis embodiment. The automated scanner system 10 shown in FIG. 1A includes a motion assembly 100. There may be one or more motion assemblies 100 incorporated in the automated scanner system 100. In the depicted embodiment, the motion assembly 100 is a servo axes driving ballscrew 102 having a carriage 104. Thus, the automated scanner system 100 has a single axis x-x. The motion assembly 100 (including the carriage 104) can be mounted to a housing 106 as a table-top system or mounted to a stand-like or frame-like apparatus for a standalone system. In another embodiment, the motion assembly 100 (with or without a housing 106) of the automated scanner system 10 can be incorporated into a larger automated system (not shown), as described in detail below.

In FIG. 1A, the motion assembly 100 has a scanner 200 mounted thereto. Specifically, the scanner 200 is mounted to the carriage 104 of the motion assembly 100. In the depicted embodiment, the scanner 200 is a 3D laser profiler. And, as shown, the 3D laser profiler 200 is mounted to the carriage 104 of the ceiling-mounted motion assembly 100. In the embodiment in FIG. 1A, the carriage 104 is mounted to the housing 106. The automated scanner system 10 includes a measurement target zone 12 where a DUT 500 is placed. The automated scanner system 10 additionally includes an integrated processor 300 and display 400 (e.g., graphical user interface (GUI)) 300/400 connected to the motion assembly 100 and the scanner 200).

In an embodiment wherein the automated scanner system 10 is a turnkey system, the user triggers the scanner 200 to take one or more measurement(s) at the desired positions along the DUT 500 in the measurement target zone 12 as the scanner 200 moves relative to the DUT 500. The user can trigger the scanner 200 to begin executing measurement tasks by doing such actions such as engaging an actuation mechanism (e.g., button) on the automated scanner system 10 (e.g., on the display 400) or placing the DUT 500 within the automated scanner system 10 (e.g., within range of the scanner) where it is recognized by a scanner 200. The scanner 200 moves according to the movement of the motion assembly 100. In the embodiment shown in FIG. 1A, the 3D laser profiler 200 has a single axis of movement along the motion assembly 100.

There are two basic motion profile types that can be configured for the automated scanner system 10: discrete and continuous. The discrete motion profile type uses a list of spatial coordinates predetermined by the user. The system 10 moves the scanner 200 to each of the listed spatial coordinates, stops the motion, and acquires the measurements. Thereafter, the scanner 200 is moved to the next spatial coordinate for acquiring additional measurements. This method is repeated until measurements are captured at each of the predetermined, listed spatial coordinates.

In an alternative embodiment, for the continuous motion profile type (i.e., scanning type), motion from a start position to a stop position. Measurements are taken during motion, at predetermined time intervals (e.g., every 10 ms) or at predetermined spatial intervals (e.g., every 1 um of travel). This method is continued until a total time has elapsed or until a maximum distance has been traveled.

As recited above, the automated scanner system 10 can be operated as a stand-alone automated scanner system 10 wherein the user manually loads and unloads DUTs 500 and runs the system 10 from a graphical user interface (GUI) 300/400. FIG. 1B depicts a stand-alone automated scanner system 10, according to an embodiment. For sake of clarity, the scanner 200 is represented by the scanning region in FIG. 1B and the carriage 104 of the motion assembly 100 is not shown.

Turning now to FIG. 1C, there is shown a stand-alone automated scanner system 10 mounted within a larger automated system 1000, such as a robotic work cell, according to an embodiment. Alternatively, the automated scanner system 10 can be operated as a piece of a larger automated system 1000, as stated above. In the larger automated system 1000, a robot 600 could load and unload parts into and out from the automated scanner system 10 as shown in FIG. 1C. DUTs 500 are placed in a measurement target zone 1002 for scanning. The measurement target zone 1002 can be a central location within the larger automated system 1000 (or near the stand-alone automated scanner system 100). The motion assembly 100 and scanner 200 (represented by the scanning region in FIG. 1C) are positioned around the measurement target zone 1002 to optimize the acquisition of measurements. The measurement target zone 1002 can be a separate stage, plate, fixture, or other material, or it can be any designated location within the automated scanner system 10 (or larger automated system 1000) for a DUT 500.

With the DUTs 500 in place on the measurement target zone 1002, scanning is initiated. The robot 600 may automatically initiate scanning (i.e., measurement tasks) by the automated scanner system 10. After the scanning is complete, the robot 600 (via an integrated processor or other computing system) will make a determination regarding the scanned DUT 500. Specifically, the determination is a judgment of the measurements and/or defect inspection. Then, the robot 600, based on the judgment will dispose of the DUT 500, either keeping the DUT 500 or rejecting the DUT 500.

If the robot 600 decides to keep the DUT 500 (based on the measurement judgment), the robot 600 will place the DUT 500 in a subsequent process (i.e., “down line”). For example, the robot 600 may place the DUT 500 on a conveyor (not shown) of the automated scanner system 10 (or larger automated system 1000) designated for good DUTs 500. On the other hand, if the robot 600 rejects the DUT 500, the DUT 500 is placed in or moved toward a designated location for rejected DUTs 500. For example, the robot 600 may place the rejected DUTs 500 in a designated non-conformance location for rejected or reworkable DUTs 500.

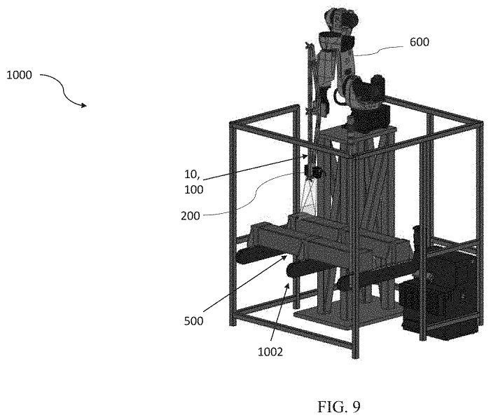

FIG. 9 shows a perspective view of a larger automated system 1000 such as a robotic work cell, according to an alternative embodiment. In the embodiment shown in FIG. 9, the scanner 200 is mounted to an EOAT (end of arm tool) 602 of the robot 600. Thus, the robot 600 is the motion assembly 100 for the scanner 200, making the automated scanner system 10 incorporated or otherwise integrated into the robot 600. The automated scanner system 10 and its components, the larger automated system 1000, and the robot 600 can work in conjunction to perform the functions described above with respect to FIG. 1C.

According to an embodiment, the GUI 300/400 (FIG. 1A) captures one or more scanned profiles of the DUT 500. In an embodiment, the GUI 300/400 captures a scanned profile based on point clouds. Point clouds are datasets that are used to construct a representation of the exterior surface of an object (or the boundaries of a space). The point clouds include multiple single points, each having X, Y, and Z coordinates and two luminosity values. The coordinates of each point are combined to represent the entire object or space. Using the scanned profile, the GUI 300/400 executes the specific measurements that were defined for the DUT 500.

Specific measurements may include: stitching the various point-cloud data from several profilers and building a solid model and then conducting physical measurements on that model, or comparing that scanned model (actual model) to the CAD model (theoretical model) for the part. The GUI 300/400 can be updated with the stitched solid model, the actual model, the CAD model, the deviations, the measurement results, and the dispositioning (i.e., pass (good part) or fail (bad part)). According to an embodiment, the results are transmitted from the GUI 300/400 to an enterprise data system or database for real-time reporting. The data system or database can be local (i.e., on the automated scanner system 10) or remote (via network/Internet transmissions).

Other configurations of the automated scanner system 10 behave in a very similar manner but have multiple axes of motion, each with its own scanner 200 or multiple scanners 200.

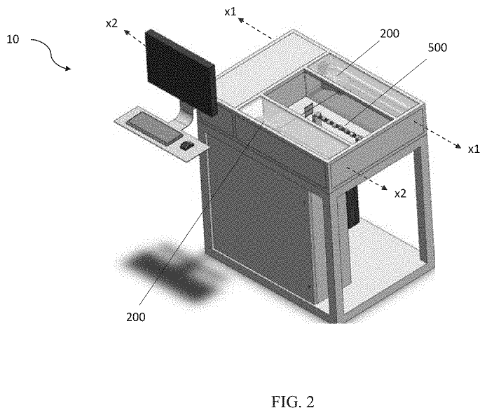

Referring now to FIG. 2, there is shown a perspective view of the automated scanner system 10, according to a two-axis parallel scanning motion embodiment. As shown in FIG. 2, the automated scanner system 10 has two axes of motion, first axis x1-x1 and second axis x2-x2. In the depicted embodiment, the two axes of motion are parallel, aligned, and directly opposed to one another. However, it is contemplated that the axes of motion could intersect. Each axis of motion has its own scanner 200, as shown. Having two axes of motion, each with its own profiler, means that the automated scanning system 10 in FIG. 2 scans two views of the DUT 500. Having multiple axes of motion providing multiple views of the DUT 500 allows the automated scanning system 10 to collect more data points (as compared to a single-axis system (FIG. 1A). With more data, more accurate models of the scanned DUT 500 can be generated.

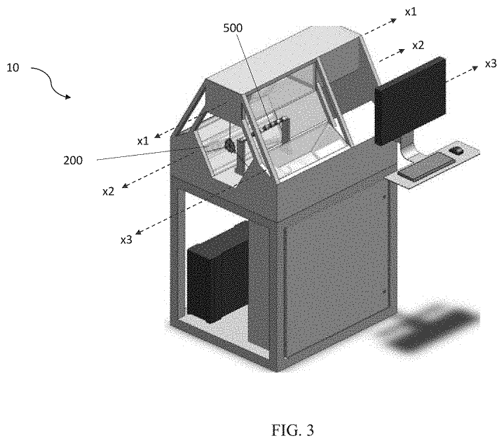

Turning now to FIG. 3, there is shown a perspective view of the automated scanner system 10, according to a three-axis embodiment. Similar to the parallel two-axis embodiment in FIG. 2, the parallel three-axis embodiment of the automated scanner system 10 has three parallel, aligned axes, first axis x1-x1, second axis x2-x2, and third axis x3-x3. In the depicted embodiment, connecting the axes forms an equilateral triangle. In other words, the angle measured from the first axis x1-x1 to both the second axis x2-x2 and the third axis x3-x3 is approximately 60°. While it is contemplated that other configurations of the axes can be utilized (e.g., wherein the axes intersect), the configuration shown in FIG. 3 optimizes the data collected from scanners 200 of three axes of motion. Note, only one scanner 200 (along the second axis x2-x2 is visible in FIG. 3).

As stated above, other configurations of the axes of motion can be utilized. For example, while the axes shown in FIGS. 1A-3 are all in a horizonal orientation, other configurations of the axes can include (or comprise solely of) axes that extend vertically. In another example, the axis or axes can include a rotary axis (e.g., via a rotary table). A rotary axis could be suitable for a DUT 500 that has an inner volume such that it would be optimal to have a scanner acquiring measurements within the inner volume of the DUT 500.

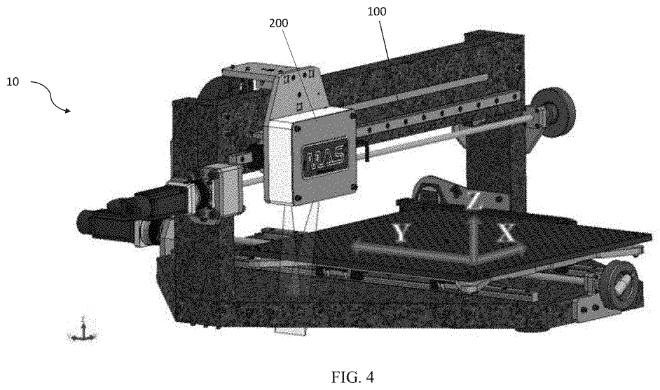

Referring to FIG. 4, there is shown a perspective view of the automated scanner system 10, according to a two-axis perpendicular scanning motion embodiment. As shown in FIG. 4, the automated scanner system 10 has two axes of motion, first axis x and second axis y. In the depicted embodiment, the two axes of motion are planar and perpendicular to one another. Planar orientation can be horizontal, vertical or any other angle. In the depicted embodiment, one axis, first axis x, traverses the scanner 200 over the DUT 500 (not shown) while the other axis, second axis y traverses the DUT 500. However, it can be contemplated that both perpendicular axes, first axis x and second axis y, traverse the DUT 500 or both axes traverse the scanner 200. In the depicted embodiment, the motion assembly 100 can be automated or manually moved by user. It can also be contemplated that a third axis z perpendicular to the first two planar axes (first axis x and second axis y) provides three-dimensional motion. For example, the first two planar axes would be motion in X and Y direction while the third axis would be motion in Z direction. Any combination of motion axes could be for moving either the scanner 200 or the DUT 500 (e.g., X, Y, Z, A, B, C).

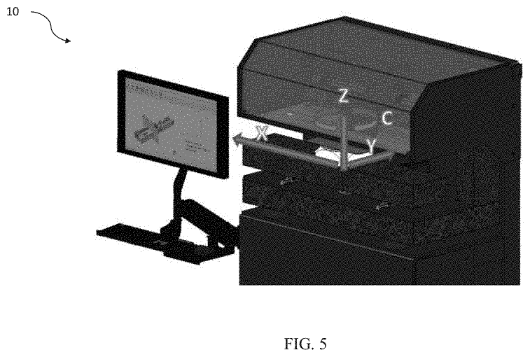

Turning now to FIG. 5, there is shown a perspective view of the automated scanner system 10, according to a three-axis perpendicular and rotary axis scanning motion embodiment. The automated scanner system 10 of FIG. 5 utilizes perpendicular axes (X, Y, Z) of motion to move either DUT 500 and/or the scanner(s) 200 (both not shown for clarity purposes). FIG. 5 also depicts a rotary axis C of motion where the DUT 500 is rotated relative to the Z axis. Rotational axes of motion enable the sensor (not shown) to acquire scans and/or images of multiple sides of the DUT 500 while multiple motion axes (e.g., X, Y, and/or Z) enable the automated scanner system 10 to acquire scans and/or images greater than the field-of-view (FOV) of the scanner(s) 200. The system 10 then uses either encoder feedback and/or a fiducial alignment method to stitch multiple scans and/or images together.

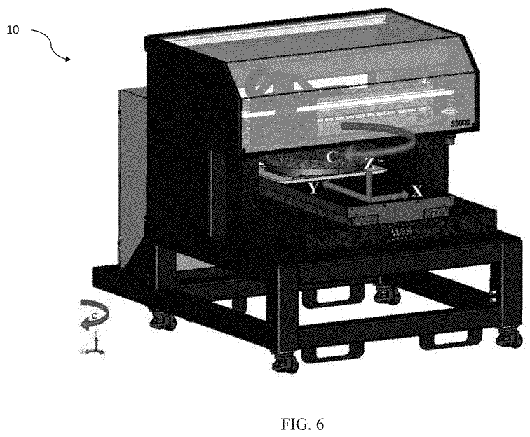

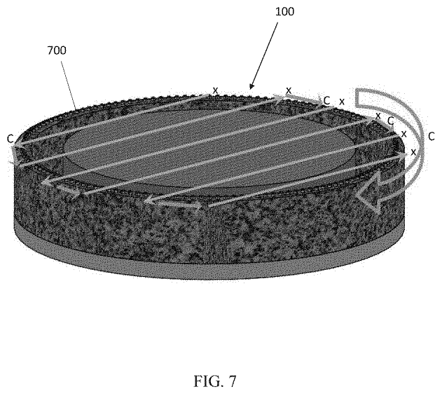

Referring briefly to FIG. 6, there is shown a perspective of a multi axes automated scanner system 10 with a rotational C axis and dual opposing scanners 200 (not shown; similar to opposing scanners in FIG. 2). As shown in FIG. 6, the X-axis traverses the scanner 200 while the Y and C axes reposition the DUT 500 between scans. Turning now to FIG. 7, there is shown the motion assembly 100 (or components thereof) with the scanning X-axis motion and the repositioning C-axis motion of the DUT 500. Also visible in FIG. 7 are a plurality of fiducial markers 600 along the perimeter of the motion assembly 100 (or components thereof) used for stitching multiple scans together to produce a three-dimensional representation of the DUT 500.

As mentioned above, fiducial markets 600 are used to stitch multiple scans together. Multiple scans must be stitched together to form three-dimensional data of the DUT 500 when the DUT 500 is larger than field-of-view (FOV) of any scanner 200. The sensors (not shown) utilized by the system 10 produce four-dimensional data (X, Y, Z positional data, and luminosity data). Using luminosity to detect fiducials 600 allows for flat fiducials 600 that do not produce any reflection or refraction artifacts. The system 10 can use light fiducials 600 on a dark background or dark fiducials on a light background. Fiducials 600 are typically circular (requiring at least 3 fiducials 600 to be shared by consecutive scans to align them), but other configurations are possible. Using fiducials 600 with an asymmetric shape would allow a single fiducial 600 to indicate both position and orientation.

The fiducials 600 are typically placed at either end of the DUT 500 being scanned; however, they could be used in other configurations, including being placed in a ring around the DUT 500 (as depicted in FIG. 7), or placed within the outside edges of the DUT 500 if the DUT 500 in question has one or more thru holes that are large enough to contain a fiducial marker 600. The only requirement is that a masking algorithm is used to identify where the software should search for fiducials 600. This masking algorithm can be as simple or as complex as necessary. The important part is that it fully masks the DUT 600 so that false positives are not detected.

To find fiducials 600, a luminosity threshold is applied to the non-masked regions of the scan. Any scanned points whose luminosity is above the threshold (for light fiducials 600) or below the threshold (for dark fiducials 600) are noted. Various techniques are then applied to improve the reliability of detecting fiducials 600, including forming regions where neighboring points on the same side of the threshold are joined into regions with each region theoretically representing 1 fiducial 600. Another technique is dilating and/or eroding for blob detection. Dilating a region increases the region to include all neighboring pixels, while eroding does the opposite by removing all edge pixels from a region.

The three-dimensional equivalents of these procedures are possible since the 3D data is arranged in a regular XY grid. Another technique is merging nearby regions. Regions of possible fiducials 600 that are within a few microns of each other are likely part of the same fiducial 600, so we can apply a variety of algorithms to merge nearby regions. Another technique is filtering regions by shape, size, location, and count. It is usually know what kind of fiducials 600 to expect and where to expect them. To rule out false positives, the regions are ordered based on how close they are to the shape, size, and location of the fiducials 600 expected to be found, and then only keep the first n regions in the sorted list (where n is the number of fiducials we expect to see).

Once fiducials 600 have been found in two different scans, an initial gross alignment is performed. This is based on just encoder feedback (e.g., if the Y position of the second scan was 10 mm larger, then the second scans is translated 10 mm in Y). After the gross alignment, fiducials 600 that appeared in both scans should be nearby. Then, nearby fiducials 600 are paired and a second finer alignment is performed to find the transformation matrix that will bring the fiducials 600 into the best possible alignment.

The two main methods used to find the transform include numeric methods and an evolutionary algorithm. Numeric methods include least-squares fitting, or similar algorithms can be used to produce a reasonable fit. Often, more exact methods are more computationally intensive, so the method must be weighed against the number of fiducials 600 and the desired precision. This method is often followed by an evolutionary algorithm for finer adjustment. Evolutionary algorithm comprises an initial guess transformation (either the gross alignment, or the result of the previous method) that is then modified repeatedly. With each iteration, the alignment is modified to produce a range of similar but slightly different alignments by varying all 6 degrees of freedom within a certain range. Then, the new alignments are evaluated with a score function and the best scoring one is kept for the next iteration. The iterations continue with smaller and smaller adjustments until a suitable fit is found.

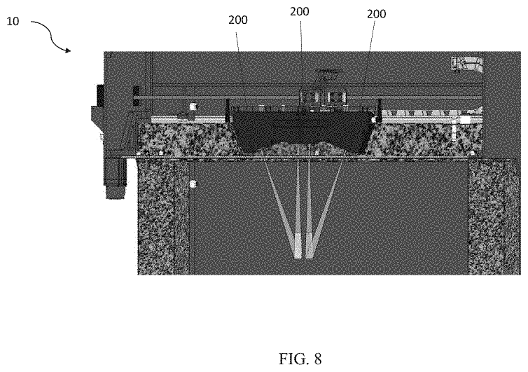

FIGS. 7 and 8 depict opposing scanners 200 that, when configured in this orientation, reduce non-visible regions where rising or falling edges (relative to scanning direction) block the sensor (not shown) from receiving the projected light. All configurations of automated scanning listed herein can be configured in opposing scanner 200 configurations as depicted in FIGS. 7 and 8.

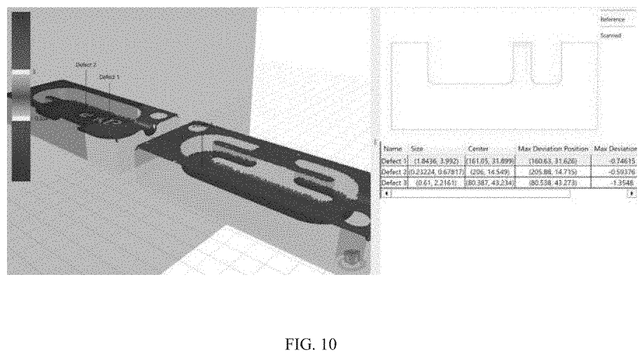

Turning now to FIG. 10, there is shown a compiled three-dimensional shape compared in the S-Series Analyzer software application against the uploaded three-dimensional model generated from a CAD system (e.g., .STL file, .STP 203 file, .STP 204 file, .STP 214 file, .IGES file, SolidWorks file, Inventor file, ProE file, AutoCAD 3D file). Measurements are then conducted on the scanned three-dimensional point cloud as well as between the scanned point cloud and the three-dimensional CAD model.

Scanning motion is commanded by three different methods. The first method is simple jog and point to point single axis or multi-axis coordinated motion commanded with start/stop command with position and velocity control. A second method is pre-programmed motion profiles pre-defined per program recipe (method commonly used for inspection of high volume of same DUT 500). The third method includes motion programs pre-programmed by CAM (computer aided manufacturing) where the MAS software determines best scanning motion profile and sequence based on CAD model geometry of the DUT 500.

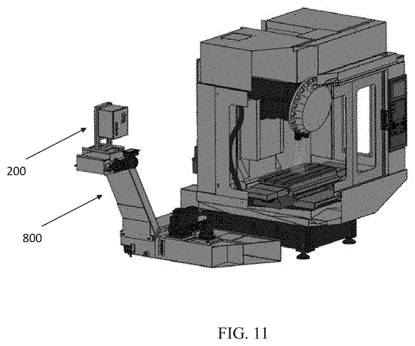

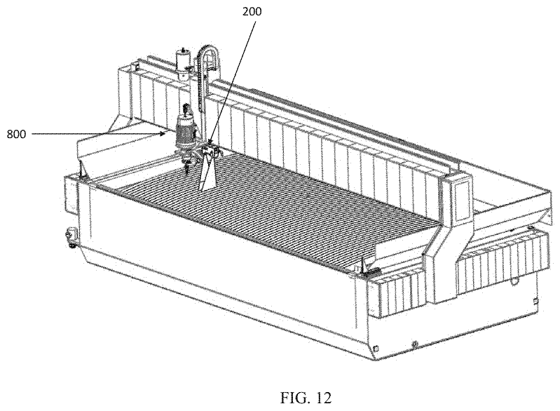

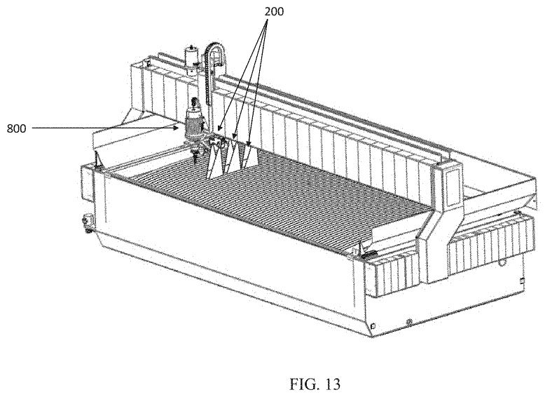

Referring now to FIG. 11, there is shown a CNC (Computer Numerical Control) 800 holding a scanner tool 200. Scanner toolings 200 can be configured as a single scanner, dual opposing scanners or an array of scanners. FIGS. 11 and 12 depict single scanner tool 200, while FIG. 13 depicts an array scanner tool 200 (i.e., an array of scanners 200). In FIG. 11, the scanner tool 200 is held in a CNC mill 800, while in FIGS. 12 and 13, the scanner tool 200 is mounted to a CNC water jet 800. However, it is contemplated that the scanner tool 200 can be fixtured or mounted to any CNC machine 800, including but not limited to: Blanchard grinder, lathe, saw, surface grinder, laser cutter, laser engraver, plasma cutter, router, 3D printer, EDM (electrical discharge machining), gear cutter etc. The scanner tool 200 can use the hoist CNC encoder feedback, external positional feedback or fiducial markers to define scanner positional data.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

The above-described embodiments of the described subject matter can be implemented in any of numerous ways. For example, some embodiments may be implemented using hardware, software or a combination thereof. When any aspect of an embodiment is implemented at least in part in software, the software code can be executed on any suitable processor or collection of processors, whether provided in a single device or computer or distributed among multiple devices/computers.

What is claimed is:

1. An automated scanner system, comprising:
a housing having a motion assembly connected thereto, the motion assembly movable along a first axis of motion within the housing;
a scanner attached to the motion assembly adapted to take one or more measurements;
a measurement target zone within the housing, wherein the scanner and motion assembly move relative to the measurement target zone and the scanner is directed toward the measurement target zone.

2. The system of claim 1, wherein the scanner is at least one of: a 3D profiler, area scan camera, line scan camera, pattern projection camera, multiple cameras imaging around DUT, telecentric lensing, displacement laser scanner, laser micrometer, a laser-based device, and a non-laser-based device.

3. The system of claim 1, wherein the motion assembly is one or more of: a linear servo motor, rotary servo motor, stepper motor, manual hand crank, ballscrew, leadscrew, rack and pinion, linear ball, roller bearing rail, air bearing stage, belt-driven mechanism, conveyors, and robot.

4. The system of claim 1, further comprising a DUT in the measurement target zone.

5. The system of claim 4, wherein the scanner is adapted to take one or more measurements of the DUT.

6. The system of claim 5, further comprising a processor connected to the scanner, wherein the processor generates a model of the DUT based on the one or more measurements from the scanner.

7. The system of claim 6, wherein the processor uses three-dimensional and four-dimensional data to align and stich multiple scanner data sets into one larger compiled three-dimensional representation of the scanned DUT.

8. An automated scanner system, comprising:
a housing having a plurality of motion assemblies connected thereto, each motion assembly movable along a separate axis of motion within the housing;
a scanner attached to at least one of the plurality of motion assemblies, each scanner adapted to take one or more measurements;
a measurement target zone within the housing, wherein each scanner and motion assembly moves relative to the measurement target zone and the scanner is directed toward the measurement target zone;
wherein the plurality of motion assemblies includes at least a first motion assembly and a second motion assembly; and
further wherein the first motion assembly moves along a first axis and the second motion assembly moves along a different, second axis.

9. The system of claim 8, wherein the first axis and the second axis are parallel.

10. The system of claim 8, wherein the first axis and the second axis are perpendicular.

11. The system of claim 8, further comprising a third motion assembly, which moves along a third axis that is different from the first axis and the second axis.

12. The system of claim 8, wherein the plurality of motion assemblies includes a rotational motion assembly, which moves along a rotational axis.

13. The system of claim 8, wherein the housing is connected within an automated system, the automated system including a robot.

14. The system of claim 8, further comprising a plurality of fiducial markers positioned along a perimeter of one of the plurality of motion assemblies.

15. The system of claim 14, wherein the plurality of fiducial markers are asymmetrically shaped.

16. The system of claim 8, further comprising a DUT in the measurement target zone.

17. The system of claim 16, further comprising a plurality of fiducial markers positioned within the DUT.

18. The system of claim 16, wherein the scanner obtains multiple scanner data sets of the DUT, which are aligned and stitched together into one larger compiled three-dimensional representation of the scanned DUT.

19. The system of claim 18, wherein three-dimensional data and four-dimensional data is used to align and stich together the multiple scanner data sets.

20. The system of claim 18, wherein the DUT is larger than the field-of-view of the scanner.

21. The system of claim 8, wherein the housing is connected within an automated system, the automated system including a CNC or a CNC Collett.
